(19) United States
(12) Patent Application Publication
(10) Pub. No.: US 2025/0361340 A1
(43) Pub. Date: Nov. 27, 2025

(54) MULTIPLE COMPONENT DISPERSANT FOR FOULING CONTROL

(71) Applicant: ECOLAB USA Inc., St. Paul, MN (US)

(72) Inventors: Yikun GUO, Shanghai (CN); Jinming ZHANG, Shanghai (CN)

(73) Assignee: ECOLAB USA Inc., St. Paul, MN (US)

(21) Appl. No.: 19/218,157

(22) Filed: May 23, 2025

(30) Foreign Application Priority Data
May 24, 2024 (CN) 202410651738.8

(51) Int. Cl. C08F 28/02; C08K 5/42

(52) U.S. Cl. CPC C08F 28/02; C08K 5/42

(57) ABSTRACT

The present disclosure provides compounds, compositions, and methods for reducing or preventing fouling in an industrial processes. A compound or composition may include a methylnaphthalene sulfonate-formaldehyde polymer and/or a sulfonated dispersant. An industrial process may include, for example, a chemical manufacturing process, such as an acrylonitrile manufacturing process. The disclosure also provides methods of manufacturing the compounds and compositions disclosed herein.

### TECHNICAL FIELD

The present disclosure relates to compounds and compositions for controlling fouling in industrial processes.

### BACKGROUND

Dispersant antifoulants may function as colloidal stabilizers that keep foulants suspended in a medium and prevent them from depositing on equipment surfaces. During production of reactive monomers, such as styrene or acrylic acid, the reactive monomers may polymerize through a radical polymerization process. Unwanted polymerization reactions often result in the production of foulants that can cause fouling and potential shutdown of operation equipment.

To solve the fouling issue in connection with production of reactive monomers, dispersants have been provided that are effective for certain reactive monomers in, for example, recovery columns and evaporators. However, there is a need for dispersant compounds and compositions that are effective during production of acrylonitrile, which may include high concentrations of ammonium sulfate as well as other inorganic matter in a medium of the production process.

### BRIEF SUMMARY

The present disclosure provides compounds, compositions, and methods for controlling fouling in industrial processes. In some embodiments, the disclosure provides a composition comprising a sulfonated dispersant and a methylnaphthalene sulfonate-formaldehyde polymer.

The disclosure also provides methods of reducing fouling in an industrial process. The methods may comprise adding an effective amount of a sulfonated dispersant to a medium in the industrial process, and adding an effective amount of methylnaphthalene sulfonate-formaldehyde polymer to the medium.

Additionally, the disclosure provides methods of preparing a composition. The methods may comprise reacting a methylnaphthalene sulfonate with formaldehyde to form a methylnaphthalene sulfonate-formaldehyde polymer; purifying the methylnaphthalene sulfonate-formaldehyde polymer by adding a solvent to form a solution; forming a sediment in the solution; separating the sediment from the solution; drying the solution to form a powder; dissolving the powder in a second solvent; and adding a sulfonated dispersant to the second solvent.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE SEVERAL VIEWS OF THE DRAWINGS

A detailed description of the invention is hereafter described with specific reference being made to the drawings in which:

FIG. 1 shows the dispersion performance by different PSS/MS mass ratios; and

FIG. 2 shows a dispersion performance comparison between NNO and an embodiment of a composition of the present disclosure (PSS/MF mass ratio of about 1:16).

### DETAILED DESCRIPTION

Various embodiments are described below. The relationship and functioning of the various elements of the embodiments will be better understood in light of the following detailed description. However, elements and embodiments are not strictly limited to those explicitly described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

As used herein “alkyl” or “alkenyl” group may have from 1 to about 29 carbon atoms; is partially or fully oxygenized. The term “cycloalkyl” by itself or as a part of another substituent refers to a cyclic alkyl group having the number of carbons designated and is a subset of the term “alkyl.” Other subsets of the term “alkyl” include “linear” and “branched” alkyl groups which refer to two different types of acyclic alkyl groups. Examples of alkyl groups include methyl, ethyl, n-propyl, isopropyl, n-butyl, t-butyl, isobutyl, sec-butyl, cyclohexyl, cyclopentyl, (cyclohexyl)methyl, cyclopropylmethyl, bicyclo[2.2.1]heptane, bicyclo[2.2.2]octane, etc. In this list of examples, the methyl, ethyl, n-propyl, and n-butyl alkyl examples are also examples of “linear alkyl” groups. Similarly, isopropyl and t-butyl are also examples of “branched alkyl” groups. Cyclopentyl, cyclohexyl, (cyclohexyl)methyl, cyclopropylmethyl, bicyclo[2.2.1]heptane, bicyclo[2.2.2]octane are examples of “cycloalkyl” groups.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)- groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (e.g., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co)polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

Disclosed herein are compounds, compositions, and methods for reducing fouling in an industrial process, such as a chemical manufacturing process. A compound may include a sulfonated dispersant. A compound may also include a methylnaphthalene sulfonate-formaldehyde polymer. A composition of the present disclosure may include a sulfonated dispersant, a methylnaphthalene sulfonate-formaldehyde polymer, optionally a solvent, and optionally a foulant.

For example, a composition may comprise, consist of, or consist essentially of a sulfonated dispersant and/or a methylnaphthalene sulfonate-formaldehyde polymer and/or a solvent, and/or a foulant.

Illustrative, non-limiting examples of a sulfonated dispersant include a sulfonated oil, a sulfonated fatty acid, a sulfated oil, a sulfated fatty acid, a naphthalene sulfonate-formaldehyde condensate, a polystyrene sulfonate, a salt of any of the foregoing, and any combination of the foregoing. A sulfonated dispersant may be, for example, in a sulfonate acid form or a salt thereof.

In some embodiments, a sulfonated dispersant of the present disclosure has the general structure:

R-(SO₃)ₙM, wherein R is a hydrocarbon group chosen from a linear or branched alkyl, aromatic, cycloalkyl, aryl, or alkenyl group.

The “M” group may be H, an alkali metal, an alkaline earth metal, an alkali metal cation, an alkaline earth metal cation, an ammonium cation, or an alkyl ammonium cation. The “n” variable may range, for example, from 1 to about 20. In some aspects, n is 1, 2, 3, 4, 5, 6, 7, 8, 9, 10, 11, 12, 13, 14, 15, 16, 17, 18, 19, 20, 1-5, 1-10, 1-15, 5-10, 5-15, 5-20, 10-20, or 15-20.

As an illustrative example, the sulfonated dispersant may be a compound of formula I:

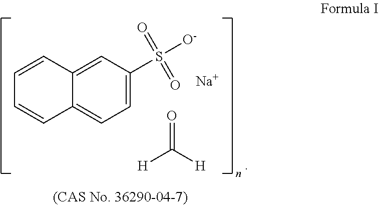

The compound of formula I may alternatively be in the form of a different salt, such as a potassium salt (CAS No. 67828-14-22) or an ammonium salt (CAS No. 9069-80-1).

In some embodiments, the sulfonated dispersant is a naphthalenesulfonic acid-formaldehyde condensation product (for example, a compound of formula I) or a mixture of different salts thereof. For example, a mixture of a naphthalene sulfonic acid-formaldehyde polymer sodium salt and a naphthalene sulfonic acid-formaldehyde potassium salt may be used as a dispersant.

As an additional illustrative example, the sulfonated dispersant may comprise a polystyrene sulfonate. The polystyrene sulfonate may be selected from, for example, sodium polystyrene sulfonate, potassium polystyrene sulfonate, ammonium polystyrene sulfonate, any other salt of polystyrene sulfonate, and any combination thereof.

The weight average molecular weight of the polystyrene sulfonate is not particularly limited. As an example, the polystyrene sulfonate may have a weight average molecular weight ranging from about 100,000 Da to about 2,000,000 Da, such as from about 100,000 Da to about 1,700,000 Da, about 100,000 Da to about 1,500,000 Da, about 100,000 Da to about 1,250,000 Da, about 100,000 Da to about 1,000,000 Da, about 100,000 Da to about 750,000 Da, about 250,000 Da to about 2,000,000 Da, about 500,000 Da to about 2,000,000 Da, about 750,000 Da to about 2,000,000 Da, about 1,000,000 Da to about 2,000,000 Da, about 750,000 Da to about 1,500,000 Da, or about 900,000 Da to about 1,200,000 Da.

Although the sulfonated dispersant and the methylnaphthalene sulfonate-formaldehyde polymer may be added separately to any medium disclosed herein, they may also be included together in a composition and that composition may be added to any medium disclosed herein to control fouling.

A composition disclosed herein may include various mass ratios of the sulfonated dispersant and the methylnaphthalene sulfonate-formaldehyde polymer. For example, a composition may comprise a mass ratio of the sulfonated dispersant to the methylnaphthalene sulfonate-formaldehyde polymer of about 1:6 to about 1:1,000, such as about 1:6 to about 1:800, about 1:6 to about 1:600, about 1:6 to about 1:400, about 1:6 to about 1:200, about 1:6 to about 1:100, about 1:6 to about 1:80, about 1:6 to about 1:60, about 1:6 to about 1:40, about 1:6 to about 1:20, about 1:6 to about 1:16, about 1:8 to about 1:1,000, about 1:8 to about 1:800, about 1:8 to about 1:600, about 1:8 to about 1:400, about 1:8 to about 1:200, about 1:8 to about 1:100, about 1:8 to about 1:80, about 1:8 to about 1:600, about 1:8 to about 1:40, about 1:8 to about 1:20, about 1:8 to about 1:16, about 1:10 to about 1:1,000, about 1:10 to about 1:800, about 1:10 to about 1:600, about 1:10 to about 1:400, about 1:10 to about 1:200, about 1:10 to about 1:100, about 1:10 to about 1:80, about 1:10 to about1:60, about 1:10 to about 1:40, about 1:10 to about 1:20, about 1:10 to about 1:16, about 1:12 to about 1:1,000, about 1:12 to about 1:800, about 1:12 to about 1:600, about 1:12 to about 1:400, about 1:12 to about 1:200, about 1:12 to about 1:100, about 1:12 to about 1:80, about 1:12 to about1:60, about 1:12 to about 1:40, about 1:12 to about 1:20, about 1:12 to about 1:16, about 1:14 to about 1:1,000, about 1:14 to about 1:800, about 1:14 to about 1:600, about 1:14 to about 1:400, about 1:14 to about 1:200, about 1:14 to about 1:100, about 1:14 to about 1:80, about 1:14 to about 1:60, about 1:14 to about 1:40, about 1:14 to about 1:20, about 1:14 to about 1:16, about 1:6 to about 1:18, about 1:8 to about 1:18, about 1:10 to about 1:18, about 1:12 to about 1:18, about 1:14 to about 1:18, or about 1:16 to about 1:18.

A composition of the present disclosure may optionally comprise a solvent. In some embodiments, a composition comprises, consists of, or consists essentially of a solvent and a sulfonated dispersant. In some embodiments, a composition comprises, consists of, or consists essentially of a solvent and a methylnaphthalene sulfonate-formaldehyde polymer. In some embodiments, a composition comprises, consists of, or consists essentially of a solvent, a sulfonated dispersant, and a methylnaphthalene sulfonate-formaldehyde polymer.

Illustrative, non-limiting examples of solvents include water, a hydroxyl-functionalized solvent, such as an alcohol, or any combination thereof. The alcohol may include, for example, a dihydric alcohol, such as ethylene glycol, glycerol, a glycol ether, and any combination thereof.

The amount of solvent in a composition is not particularly limited. For example, a composition may comprise from about 1 wt. % to about 99 wt. % of the solvent, such as from about 10 wt. % to about 99 wt. %, about 20 wt. % to about 99 wt. %, about 30 wt. % to about 99 wt. %, about 40 wt. % to about 99 wt. %, about 50 wt. % to about 99 wt. %, about 60 wt. % to about 99 wt. %, about 70 wt. % to about 99 wt. %, about 80 wt. % to about 99 wt. %, about 90 wt. % to about 99 wt. %, about 10 wt. % to about 95 wt. %, about 10 wt. % to about 90 wt. %, about 10 wt. % to about 85 wt. %, about 10 wt. % to about 80 wt. %, about 10 wt. % to about 75 wt. %, about 25 wt. % to about 75 wt. %, about 25 wt. % to about 85 wt. %, about 25 wt. % to about 95 wt. %, about 50 wt. % to about 95 wt. %, about 50 wt. % to about 90 wt. %, about 50 wt. % to about 85 wt. %, about 65 wt. % to about 95 wt. %, or about 65 wt. % to about 95 wt. %.

As an illustrative, non-limiting example, a composition of the present disclosure may include about 0.1 wt. % to about 5 wt. % of the sulfonated dispersant, about 0.1 wt. % to about 50 wt. % of the methylnaphthalene sulfonate-formaldehyde polymer, and from about 50 wt. % to about 99 wt. % of the solvent, such as from about 55 wt. % to about 90 wt. %, about 55 wt. % to about 85 wt. %, about 55 wt. % to about 80 wt. %, about 55 wt. % to about 75 wt. %, about 55 wt. % to about 70 wt. %, or about 55 wt. % to about 65 wt. %.

For example, the composition may include from about 0.1 wt. % to about 4 wt. %, about 0.1 wt. % to about 3 wt. %, about 0.1 wt. % to about 2 wt. %, about 0.1 wt. % to about 1 wt. %, about 0.5 wt. % to about 5 wt. %, about 1 wt. % to about 5 wt. %, about 2 wt. % to about 5 wt. %, about 3 wt. % to about 5 wt. %, about 2 wt. % to about 4 wt. %, about 2 wt. %, about 3 wt. %, or about 4 wt. % of the sulfonated dispersant.

As an additional example, the composition may include from about 0.1 wt. % to about 45 wt. %, about 0.1 wt. % to about 40 wt. %, about 0.1 wt. % to about 35 wt. %, about 0.1 wt. % to about 30 wt. %, about 0.1 wt. % to about 25 wt. %, about 0.1 wt. % to about 20 wt. %, about 0.1 wt. % to about 15 wt. %, about 0.1 wt. % to about 10 wt. %, about 0.1 wt. % to about 5 wt. %, about 0.1 wt. % to about 1 wt. %, about 1 wt. % to about 3 wt. %, about 1 wt. % to about 5 wt. %, about 1 wt. % to about 7 wt. %, about 1 wt. % to about 10 wt. %, about 1 wt. % to about 15 wt. %, about 1 wt. % to about 20 wt. %, or about 1 wt. % to about 25 wt. %.

When the compositions disclosed herein are used to reduce fouling in an industrial process, they will encounter foulants in a medium to which they are added. In certain aspects, those foulants may form a part of the composition such that a composition of the present disclosure may comprise, consist of, or consist essentially of a foulant, optionally a solvent, optionally a methylnaphthalene sulfonate-formaldehyde polymer, and/or optionally a sulfonated dispersant.

The chemical composition of the foulant will differ depending upon the medium to which the compound or composition is being added. For example, if a compound or composition of the present disclosure is being added to an aqueous medium in an acrylonitrile manufacturing process, a foulant may be a complicated mixture of organic and/or inorganic compounds. As examples, the foulant may include organic polymers, a sulfate salt, such as ammonium sulfate, a calcium salt, polyacrylonitrile, polyacrylic acid, acrylic acid, and any combination thereof.

Any method known to one of skill in the art may be used to prepare the compounds (e.g., the sulfonated dispersant, the methylnaphthalene sulfonate-formaldehyde polymer, etc.) and compositions of the present disclosure.

For example, a process may include preparing/obtaining the sulfonated dispersant, purifying the sulfonated dispersant, drying the purified sulfonated dispersant, and optionally dissolving the sulfonated dispersant in a solvent.

The production of the sulfonated dispersant may be carried out by the process of sulfonation with sulfuric acid, for example, or the production of the sulfonated dispersant may be carried out by the process of condensation with formaldehyde. Alternatively, the production of the sulfonated dispersant maybe carried out by the process of neutralization with an alkali liquor or a mixture of alkali liquors and drying the resulting product to form a powder.

In some embodiments, an alkali mixture of potassium hydroxide and sodium hydroxide is added to adjust the pH in the range of about 5 to about 11 during the sub-process of neutralization. In some embodiments, the pH ranges from about 6 to about 10, about 7 to about 10, about 8 to about 10, about 6 to about 9, about 6 to about 8, or about 6 to about 7. The molar ratio of potassium hydroxide to sodium hydroxide may be. For example, about 100:1 to about 1:100, such as about 3:1 to about 10:1.

The raw sulfonated dispersant may comprise a mixture of the formed sulfonates produced by any of the previously mentioned methods.

Purification of the raw sulfonated dispersant may be achieved by adding a poor solvent for the sulfates, such as methanol, into the dispersant solution and blending the mixture to form a sediment. Other poor solvents include, but are not limited to, ethanol, propyl alcohol, and isopropanol.

The content of sulfates in the dispersant may be decreased by adding calcium hydroxide or calcium oxide to form calcium sulfate. However, the residual calcium ions may have negative effects (such as fouling) during the subsequent applications.

The poor solvent may reduce the amount of inorganic impurities in the sulfonated dispersant to about 5 wt. % or less, such as about 3 wt. % or less, about 1 wt. % or less, or about 0.5 wt. % or less.

After the formed sediment is separated, the solution may be dried to form a purified sulfonated dispersant. If desired, the purified sulfonated dispersant may be dissolved in any solvent disclosed herein, such as water, a polyhydric alcohol, or any combination thereof, and mixed to a desirable concentration.

Likewise, a process for producing the methylnaphthalene sulfonate-formaldehyde polymer may include preparing/obtaining the methylnaphthalene sulfonate-formaldehyde polymer, purifying the methylnaphthalene sulfonate-formaldehyde polymer, drying the purified methylnaphthalene sulfonate-formaldehyde polymer, and optionally dissolving the methylnaphthalene sulfonate-formaldehyde polymer in a solvent.

The production of the methylnaphthalene sulfonate-formaldehyde polymer may be carried out by, for example, a condensation reaction with formaldehyde and methylnaphthalene sulfonate. The raw methylnaphthalene sulfonate-formaldehyde polymer may comprise a mixture of sulfonates.

Purification of the raw methylnaphthalene sulfonate-formaldehyde polymer may be achieved by adding a poor solvent for the sulfates, such as methanol, into the raw methylnaphthalene sulfonate-formaldehyde polymer mixture and blending the mixture to form a sediment. Other poor solvents include, but are not limited to, ethanol, propyl alcohol, and isopropanol.

The content of sulfates in the mixture may be decreased by adding calcium hydroxide or calcium oxide to form calcium sulfate. However, the residual calcium ions may have negative effects (such as fouling) during the subsequent applications.

The poor solvent may reduce the amount of inorganic impurities in the methylnaphthalene sulfonate-formaldehyde polymer mixture to about 5 wt. % or less, such as about 3 wt. % or less, about 1 wt. % or less, or about 0.5 wt. % or less.

After the formed sediment is separated, the mixture may be dried to form a purified methylnaphthalene sulfonate-formaldehyde polymer. If desired, the purified methylnaphthalene sulfonate-formaldehyde polymer may be dissolved in any solvent disclosed herein (which may also be referred to as a “second solvent”), such as water, a polyhydric alcohol, or any combination thereof, and mixed to a desirable concentration.

The dried methylnaphthalene sulfonate-formaldehyde polymer may be added to a medium and/or the dried methylnaphthalene sulfonate-formaldehyde polymer may be added to a solvent and the resulting solution may be added a medium. The dried sulfonated dispersant may be added to a medium and/or the dried sulfonated dispersant may be added to a solvent and the resulting solution may be added a medium. Moreover, dried methylnaphthalene sulfonate-formaldehyde polymer and dried sulfonated dispersant may be combined and added to a medium and/or the dried methylnaphthalene sulfonate-formaldehyde polymer may be added to a solvent to form a first mixture, the sulfonated dispersant may be added to the first mixture to form a second mixture, and the second mixture may be added a medium. The methylnaphthalene sulfonate-formaldehyde polymer and the sulfonated dispersant may be added in any order to the solvent.

In an illustrative embodiment, a method of preparing a composition comprises reacting a methylnaphthalene sulfonate with formaldehyde to form a methylnaphthalene sulfonate-formaldehyde polymer; purifying the methylnaphthalene sulfonate-formaldehyde polymer by adding a solvent to form a solution; forming a sediment in the solution; separating the sediment from the solution (by filtration or the like); drying the solution to form a powder; dissolving the powder in a second solvent; and adding a sulfonated dispersant to the second solvent.

The solvent may be methanol, ethanol, propyl alcohol, and/or isopropanol, for example. The second solvent may be, for example, water and/or a dihydric alcohol, such as ethylene glycol, glycerol, a glycol ether, and any combination thereof.

The compounds and compositions disclosed herein may be added to various industrial processes to reduce fouling. For example, they may be added to a medium in a chemical manufacturing processes. Illustrative, non-limiting examples of chemical manufacturing processes include an acrolein manufacturing process, an acrylic acid manufacturing process, an acrylic ester manufacturing process, an acrylonitrile manufacturing process, a vinyl acetate manufacturing process, a styrene manufacturing process, or any combination thereof. The sulfonated dispersant and the methylnaphthalene sulfonate-formaldehyde polymer help remove the foulant from the medium (or prevent it from forming) and therefore extend the run length of the process.

A foulant can be a complicated mixture containing various components including polymeric foulants and/or inorganic foulants. It has been discovered that, in some embodiments, the methylnaphthalene sulfonate-formaldehyde polymer removes polymeric foulants from the system and/or prevents them from forming and the sulfonated dispersant removes inorganic foulants from the system and/or prevents them from forming.

In an illustrative, non-limiting embodiment, a method of reducing fouling in an industrial process includes adding an effective amount of a sulfonated dispersant to a medium in the industrial process and adding an effective amount of methylnaphthalene sulfonate-formaldehyde polymer to the medium.

The compounds and compositions disclosed herein can be added to a medium manually and/or automatically, continuously or intermittently, by any means known in the art. For example, they may be injected by a pump or flow meter at any position in an industrial process where foulant is generated or may accumulate. Examples of locations where foulant may be generated or may accumulate include, but are not limited to, an ammonium sulfate unit, a recovery column, a four-stage evaporator, a purification column, or a reboiler.

The compounds and compositions may be added to the medium in any order. For example, the methylnaphthalene sulfonate-formaldehyde polymer may be added to the medium before, after, and/or with the sulfonated dispersant.

The medium contemplated herein may be any medium found in an industrial process, such as an aqueous or water-containing medium found in a chemical manufacturing process (e.g., a medium of an acrylonitrile manufacturing process, such as an aqueous medium in an ammonium sulfate unit).

The amount of methylnaphthalene sulfonate-formaldehyde polymer added to the medium to be treated may range from about 0.1 ppm to about 10,000 ppm, such as about 0.1 ppm to about 8,000 ppm, about 0.1 ppm to about 6,000 ppm, about 0.1 ppm to about 4,000 ppm, about 0.1 ppm to about 2,000 ppm, about 0.1 ppm to about 1,000 ppm, about 0.1 ppm to about 500 ppm, about 0.1 ppm to about 250 ppm, about 0.1 to about 100 ppm, about 0.1 to about 50 ppm, about 1 ppm top about 10,000 ppm, about 1 ppm to about 5,000 ppm, about 1 ppm to about 1,000 ppm, about 1 ppm to about 500 ppm, about 25 ppm to about 1,000 ppm, about 50 ppm to about 1,000 ppm, about 100 ppm to about 1,000 ppm, about 200 ppm to about 1,000 ppm, about 500 ppm to about 1,000 ppm, about 25 ppm to about 500 ppm, or about 50 ppm to about 250 ppm.

The amount of the sulfonated dispersant added to the medium to be treated may range from about 0.1 ppm to about 10,000 ppm, such as about 0.1 ppm to about 8,000 ppm, about 0.1 ppm to about 6,000 ppm, about 0.1 ppm to about 4,000 ppm, about 0.1 ppm to about 2,000 ppm, about 0.1 ppm to about 1,000 ppm, about 0.1 ppm to about 500 ppm, about 0.1 ppm to about 250 ppm, about 0.1 to about 100 ppm, about 0.1 to about 50 ppm, about 1 ppm top about 10,000 ppm, about 1 ppm to about 5,000 ppm, about 1 ppm to about 1,000 ppm, about 1 ppm to about 500 ppm, about 25 ppm to about 1,000 ppm, about 50 ppm to about 1,000 ppm, about 100 ppm to about 1,000 ppm, about 200 ppm to about 1,000 ppm, about 500 ppm to about 1,000 ppm, about 25 ppm to about 500 ppm, or about 50 ppm to about 250 ppm.

After addition of the methylnaphthalene sulfonate-formaldehyde polymer and the sulfonated dispersant to a medium, the medium to which the chemicals were added may have a mass ratio of the sulfonated dispersant to the methylnaphthalene sulfonate-formaldehyde polymer of about 1:6 to about 1:1,000, such as about 1:6 to about 1:800, about 1:6 to about 1:600, about 1:6 to about 1:400, about 1:6 to about 1:200, about 1:6 to about 1:100, about 1:6 to about 1:80, about 1:6 to about 1:60, about 1:6 to about 1:40, about 1:6 to about 1:20, about 1:6 to about 1:16, about 1:8 to about 1:1,000, about 1:8 to about 1:800, about 1:8 to about 1:600, about 1:8 to about 1:400, about 1:8 to about 1:200, about 1:8 to about 1:100, about 1:8 to about 1:80, about 1:8 to about 1:60, about 1:8 to about 1:40, about 1:8 to about 1:20, about 1:8 to about 1:16, about 1:10 to about 1:1,000, about 1:10 to about 1:800, about 1:10 to about 1:600, about 1:10 to about 1:400, about 1:10 to about 1:200, about 1:10 to about 1:100, about 1:10 to about 1:80, about 1:10 to about 1:60, about 1:10 to about 1:40, about 1:10 to about 1:20, about 1:10 to about 1:16, about 1:12 to about 1:1,000, about 1:12 to about 1:800, about 1:12 to about 1:600, about 1:12 to about 1:400, about 1:12 to about 1:200, about 1:12 to about 1:100, about 1:12 to about 1:80, about 1:12 to about 1:60, about 1:12 to about 1:40, about 1:12 to about 1:20, about 1:12 to about 1:16, about 1:14 to about 1:1,000, about 1:14 to about 1:800, about 1:14 to about 1:600, about 1:14 to about 1:400, about 1:14 to about 1:200, about 1:14 to about 1:100, about 1:14 to about 1:80, about 1:14 to about 1:60, about 1:14 to about 1:40, about 1:14 to about 1:20, about 1:14 to about 1:16, about 1:6 to about 1:18, about 1:8 to about 1:18, about 1:10 to about 1:18, about 1:12 to about 1:18, about 1:14 to about 1:18, or about 1:16 to about 1:18.

The foregoing may be better understood by reference to the following examples, which are intended for illustrative purposes and are not intended to limit the scope of the disclosure or its application in any way.

### EXAMPLES

Several chemicals and their combinations were tested to determine their effect on foulants from an ammonia sulfate unit. A sample of foulant deposit material was taken from the ammonia sulfate unit of an acrylonitrile plant. The foulant sample was dried and ground into powder. A foulant solution was prepared by dissolving the foulant powder in an organic solvent. In a 15 mL volume centrifugal tube, 10 mL of the ammonia sulfate water stream from the same acrylonitrile plant was added. About 400 uL of the above prepared foulant solution was added to the centrifugal tube. The content in the tube was shaken and then the tube was allowed to stand at ambient temperature. Precipitation was seen in the tube. After about 10 minutes, the precipitate was recorded at the bottom of the tube.

An equation to represent dispersion performance:

Y=(V0−V1)/V0×100%. Here, V0 is the deposit volume in the Blank test, V1 is the deposit volume with chemicals at the same time.

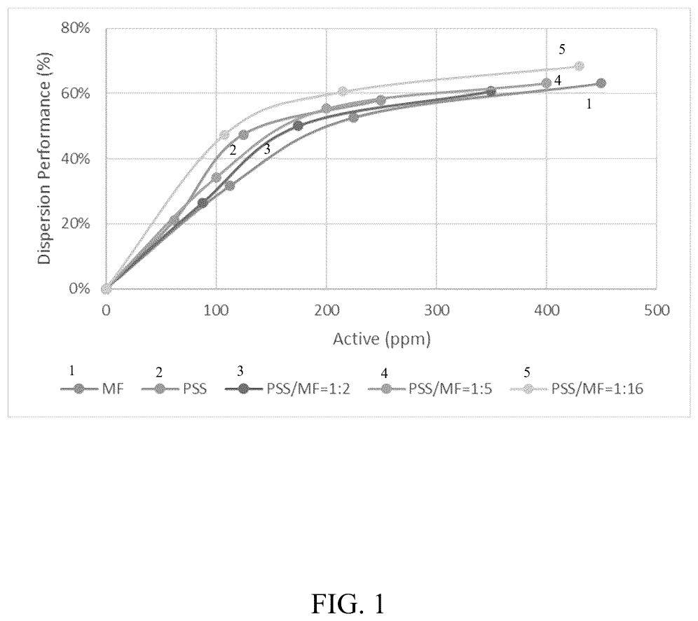

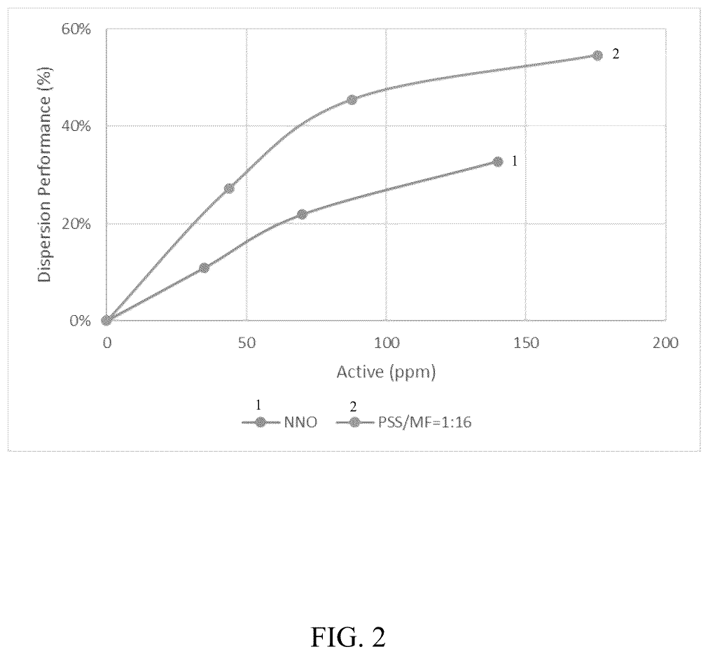

The effect of different polystyrene sulfonate (PSS)/methylnaphthalene sulfonate-formaldehyde polymer (MF) mass ratios on dispersion performance was investigated. Results are shown in FIG. 1 and in Table 1. As can be seen in FIG. 1 and Table 1, a synergistic effect was found with certain mass ratios, such as about 1:9 to about 1:50. The performance comparison between a commercial product dispersant (naphthalene sulfonate-formaldehyde polymer (NNO)) and the inventive formulae further validate that the inventive formulae have superior dispersion performance (as can be seen in FIG. 2).

TABLE 1

| | | PSS:MF | PSS:MF | PSS:MF | PSS:MF | PSS:MF | PSS:MF | |
|---|---|---|---|---|---|---|---|---|
| | MF | 1:75 | 1:50 | 1:25 | 1:9 | 1:7 | 1:3 | PSS |
| 100 ppm | 28% | 35% | 41% | 45% | 42% | 37% | 34% | 40% |
| 300 ppm | 55% | 58% | 64% | 66% | 61% | 58% | 52% | 60% |
| 500 ppm | 64% | 65% | 69% | 71% | 67% | 65% | 63% | 67% |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a solvent” is intended to include “at least one solvent” or “one or more solvents.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, compound, component and/or ingredient disclosed herein or any combination of two or more of the elements, compounds, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, compounds, components, ingredients and/or method steps.

The transitional phrase “consisting of” excludes any element, compound, component, ingredient, and/or method step not specified in the claim.

The transitional phrase “consisting essentially of” limits the scope of a claim to the specified elements, compounds, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A composition, comprising:
a sulfonated dispersant and a methylnaphthalene sulfonate-formaldehyde polymer.

2. The composition of claim 1, wherein the sulfonated dispersant is selected from the group consisting of a sulfonated oil, a sulfonated fatty acid, a polystyrene sulfonate, and any combination thereof.

3. The composition of claim 2, wherein the polystyrene sulfonate is selected from the group consisting of sodium polystyrene sulfonate, potassium polystyrene sulfonate, ammonium polystyrene sulfonate, and any combination thereof.

4. The composition of claim 2, wherein the polystyrene sulfonate has a weight average molecular weight of about 100,000 Da to about 2,000,000 Da.

5. The composition of claim 1, wherein the composition comprises a mass ratio of the sulfonated dispersant to the methylnaphthalene sulfonate-formaldehyde polymer of about 1:6 to about 1:1,000.

6. The composition of claim 1, wherein the composition comprises a solvent selected from water, a hydroxyl-functionalized solvent, or any combination thereof.

7. The composition of claim 6, wherein the composition comprises about 0.1 wt. % to about 5 wt. % of the sulfonated dispersant, about 0.1 wt. % to about 50 wt. % of the methylnaphthalene sulfonate-formaldehyde polymer, and from about 50 wt. % to about 99 wt. % of the solvent.

8. The composition of claim 1, further comprising a foulant selected from the group consisting of a sulfate salt, a calcium salt, a polyacrylonitrile, a polyacrylic acid, and any combination thereof.

9. A method of reducing fouling in an industrial process, comprising:
adding an effective amount of a sulfonated dispersant to a medium in the industrial process, and
adding an effective amount of methylnaphthalene sulfonate-formaldehyde polymer to the medium.

10. The method of claim 9, wherein the industrial process is an acrolein manufacturing process, an acrylic acid manufacturing process, an acrylic ester manufacturing process, an acrylonitrile manufacturing process, a vinyl acetate manufacturing process, a styrene manufacturing process, or any combination thereof.

11. The method of claim 9, wherein the effective amount of the sulfonated dispersant is from about 0.1 ppm to about 10,000 ppm and/or the effective amount of the methylnaphthalene sulfonate-formaldehyde polymer is from about 0.1 ppm to about 10,000 ppm.

12. The method of claim 9, wherein the sulfonated dispersant is added before, after, and/or with the methylnaphthalene sulfonate-formaldehyde polymer.

13. The method of claim 9, wherein the medium is an aqueous medium comprising a foulant selected from the group consisting of a sulfate salt, a calcium salt, a polyacrylonitrile, a polyacrylic acid, and any combination thereof.

14. The method of claim 9, wherein an ammonium sulfate unit comprises the medium.

15. The method of claim 9, wherein the sulfonated dispersant is selected from the group consisting of a sulfonated oil, a sulfonated fatty acid, a polystyrene sulfonate, and any combination thereof.

16. The method of claim 9, wherein a composition comprises the methylnaphthalene sulfonate-formaldehyde polymer and the sulfonated dispersant, further wherein the composition comprises a mass ratio of the sulfonated dispersant to the methylnaphthalene sulfonate-formaldehyde polymer of about 1:6 to about 1:1,000.

17. A method of preparing a composition, comprising:
reacting a methylnaphthalene sulfonate with formaldehyde to form a methylnaphthalene sulfonate-formaldehyde polymer;
purifying the methylnaphthalene sulfonate-formaldehyde polymer by adding a solvent to form a solution;
forming a sediment in the solution;
separating the sediment from the solution;
drying the solution to form a powder;
dissolving the powder in a second solvent; and
adding a sulfonated dispersant to the second solvent.

18. The method of claim 17, wherein the solvent is methanol.

19. The method of claim 17, wherein the second solvent is selected from water, a hydroxyl-functionalized solvent, or any combination thereof.

20. The method of claim 17, wherein the sulfonated dispersant is selected from the group consisting of a sulfonated oil, a sulfonated fatty acid, a polystyrene sulfonate, and any combination thereof.
